(19) United States
(12) Patent Application Publication
(10) Pub. No.: US 2014/0362668 A1
(43) Pub. Date: Dec. 11, 2014

(54) Indicating Locations

(71) Applicant: OPTASENSE HOLDINGS LIMITED, Farnborough, Hampshire (GB)

(72) Inventor: Magnus McEwen-King, Farnborough (GB)

(21) Appl. No.: 14/375,922

(22) PCT Filed: Feb. 1, 2013
(86) PCT No.: PCT/GB2013/050232

§ 371 Date: Jul. 31, 2014

(30) Foreign Application Priority Data
Feb. 1, 2012 (GB) 1201727.3

(51) Int. Cl. G01S 1/74

(52) U.S. Cl. CPC G01S 1/74
USPC 367/118

(57) ABSTRACT

This application describes methods and apparatus for remotely indicating a location of interest in an area, for instance the location of an event in the area. The method comprises positioning an acoustic source at the location of interest, activating the acoustic source to produce a predetermined acoustic output and performing distributed acoustic sensing on at least one optical fibre deployed at least partly in the area. The acoustic source thus acts as an acoustic marker which can be remotely detected by the distributed acoustic sensor. The acoustic signals detected by the distributed acoustic sensor are therefore analysed to detect said predetermined acoustic output and determine the location of the acoustic source. The method is particularly applicable to transport networks already provided with optical fibre along the length of the network and can be used to indicate the location of work parties or emergencies.

The present invention relates to methods and apparatus for indicating the location of an event to a remote location and in particular to indicating the location of an event on a transport network to a control station.

On transport networks there can be a desire to know the location of an event. For instance on rail networks there may sometimes be work crews performing maintenance or other tasks on or near the rail track. For engineering works on the track itself the relevant section of track may be closed and trains diverted or cancelled. However sometimes the works are such that at least some trains may still be moving on the relevant section of network, possibly with speed restrictions or the like. In such instances it may be wished to give the work party advance warning of an oncoming train so they can stay safely out of the way until it passes and/or ensure that speed restriction is applied in the right place.

In order to close the relevant section of the rail network, or impose the correct speed restrictions and to be able to inform the work party of an incoming train it is obviously necessary to know the location of the ongoing work.

Conventionally this may be done by planning and authorizing the work in advance and then putting any necessary diversions or service restrictions in place. When the crew arrives at the planned site they may make contact with a control station to indicate that they are ready and to request authorization to start work. When they are finished the work crew may then contact the control room to indicate that any restrictions imposed on that area can be removed.

This however relies on the work crew actually going to the planned location and the control centre personnel also knowing the correct location. It is possible for mistakes in respect of location to be made at either side which could potentially be hazardous for the work crew and/or the train operators and any passengers.

In addition sometimes work may be scheduled along a relatively long stretch of the network but at any one time the work party is operating only on a small section of that stretch. For safety speed limits may be applied along the whole section and the work crew may be stood down for the time taken for a train to transit the entire section. Also sometimes it may be known that work is required somewhere in a stretch of the network but not exactly where. Again then the whole of the relevant section may be identified as a restricted zone and the crew may be stood down any time a train is within the restricted zone. This may result in delays for both the work crew and the train that would be reduced if the current location of the work crew were better specified.

It is therefore an object of the present invention to provide better location of events, especially in a transport network such as a road or rail network.

Thus according to the present invention there is provided a method of identifying a location of interest within an area comprising: positioning an acoustic source at the location of interest; activating the acoustic source to produce a predetermined acoustic output; performing distributed acoustic sensing on at least one optical fibre deployed at least partly in said area; and analysing the acoustic signals detected by said distributed acoustic sensing to detect said predetermined acoustic sequence and determine the location of said acoustic source.

The method of this aspect of the present invention thus uses an acoustic source with a predetermined output as an acoustic marker which can be detected by distributed acoustic sensing (DAS). Distributed acoustic sensing is a known type of sensing where an optical fibre is used as a sensing fibre and repeatedly interrogated with electromagnetic radiation to provide sensing of acoustic activity along its length. Typically one or more input pulses of radiation are launched into the optical fibre. By analysing the radiation backscattered from within the fibre, the fibre can effectively be divided into a plurality of discrete sensing portions which may be (but do not have to be) contiguous. Within each discrete sensing portion mechanical disturbances of the fibre, for instance, strains due to incident acoustic waves, cause a variation in the properties of the radiation which is backscattered from that portion. This variation can be detected and analysed and used to give a measure of the intensity of disturbance of the fibre at that sensing portion. Thus the DAS sensor effectively acts as a linear sensing array of acoustic sensing portions of optical fibre. The length of the sensing portions of fibre is determined by the characteristics of the interrogating radiation and the processing applied to the backscatter signals but typically sensing portions of the order of a few meters to a few tens of meters or so may be used. As used in this specification the term “distributed acoustic sensing” will be taken to mean sensing by optically interrogating an optical fibre to provide a plurality of discrete acoustic sensing portions distributed longitudinally along the fibre and the term “distributed acoustic sensor” shall be interpreted accordingly. The term “acoustic” shall mean any type of pressure wave or mechanical disturbance that may result in a change of strain on an optical fibre and for the avoidance of doubt the term acoustic be taken to include ultrasonic and subsonic waves as well as seismic waves.

DAS can be operated to provide many sensing channels over a long length of fibre, for example DAS can be applied on fibre lengths of up to 40 km or more with contiguous sensing channels of the order of 10 m long.

DAS has been proposed for perimeter monitoring and detecting third party interference with linear assets such as pipelines. The advantages of DAS also make it suitable for monitoring in respect of transport networks such as road or rail networks.

Thus there are environments where DAS is already being used to provide detection of intruders or the like and it is envisaged that DAS may increasingly be used in transport networks, for instance for monitoring traffic flow.

Transport networks also often have optical fibre deployed along at least part of the network, for example for communication with various network sensors and/or traffic control systems. As mentioned DAS can be employed using standard optical communications fibre and often in any fibre deployment there are additional optical fibres provided for redundancy. Thus even in transport networks where fibre optic sensors are not currently deployed the ability to implement DAS may readily exist.

The use of acoustic sources as acoustic markers together with remote detection by DAS thus allows accurate detection of the actual location of interest. Consider a work party operating on a section of rail network which can be monitored using DAS. The work party may reach the general area where work is to be performed and contact a control centre for authorization to enter the track as normal. The control centre may check that it is safe for the work party to enter and give authorization. Once the work party is in position the acoustic source may be placed (in a suitable position) at that location, i.e. the location of the work party, and activated. The acoustic signals generated by the acoustic source when activated may be detected by the DAS system and relayed to the control centre. The DAS system can then determine the origin of the detected acoustic signals and hence the location of the acoustic source. The detection of the location of the acoustic source then identifies the location of the work party. If there is any discrepancy between the planned location and the detected location a check can be performed and if the planned location is correct the work party can be contacted for clarification.

Knowing the exact location of the work party may allow the restricted area around the work party to be minimised to what is needed for safety, reducing the time spent by trains at low speed and/or the down time spent by the work party.

The method therefore relates to identifying a location of interest in an area monitored by a DAS system by positioning an acoustic source at the location of interest, and detecting the acoustic signals generated by the acoustic source and the origin of such signals in order to identify the location of interest. Where the DAS system is provided to provide other monitoring functions, such as tracking the location/movement of vehicle on a transport network for example, the method provides a way of registering a location of interest directly with the DAS monitoring system. In other words rather than rely on a work party making contact with a control room operator to identify their location and the control room operator to correctly map the location details to the control function, the activation of the acoustic source allows the DAS system to directly detect where the relevant location is.

As mentioned the method involves analysing the acoustic signals detected by said distributed acoustic sensing to detect said predetermined acoustic sequence and determine the location of said acoustic source. In some application determining the location of the acoustic source may involve determining where along the length of a sensing fibre the acoustic source is positioned.

For instance in the application to rail monitoring the optical fibre(s) used for monitoring the rail network may be laid to run generally along the path of the rail track. If the method is therefore used to indicate a location of interest along the rail track it may therefore be sufficient to identify the position along the relevant sensing fibre of interest where the acoustic source is located. This may involve identifying the channel or channels of the DAS sensor which detect the predetermined acoustic sequence, i.e. determining which longitudinal sensing portions of the fibre have detected the relevant acoustic sequence. If multiple channels detect the predetermined acoustic sequence the detected signals may be analysed to determine which channel is closest to the acoustic source, for instance by looking at the time of arrival of the acoustic signals at the various channels and/or relative intensities or frequencies etc. One skilled in the art of DAS sensing will be well aware of various techniques that can be used to identify the origin of an acoustic signal detected by a DAS sensor.

The position of the sensing fibres in relation to the area being monitored will generally be known. For example if DAS is being used for monitoring a transport network the location of the fibre(s) along the network will be known—the position of the fibres may have been recorded when laid and/or the location may have been determined previously in a calibration process.

In some applications determining the location of the acoustic source may include determining the degree of lateral offset of the acoustic source from the sensing fibre.

The predetermined acoustic output may comprise at least a first coded sequence. The coded sequence may be coded to provide a variety of information to the control room receiving the DAS signals. For instance in the application to work parties on a rail network say the coding could be arranged to identify the relevant work party. A different work party could use a different coding and thus multiple work parties could be active in the area, each using their own coded source to separately identify themselves and their location.

In one embodiment the acoustic source may comprise a ground vibration source, for instance a ground hammer or thumper device. Ideally the acoustic source is relatively portable and can be placed readily in a location with good acoustic coupling to the DAS fibre. For instance for a buried fibre a ground vibration source may be used to excite the ground. Were the fibre to be attached to a rail of a rail track for instance an electromechanical actuator may be deployed adjacent the base of the rail—possibly adjacent the actual sensing fibre. The acoustic source is preferably man portable but in some instances a vehicle mounted source may be used.

The method may involve locating at least a first acoustic source at a first position at the location of interest and a second acoustic source at a second position at the location of interest. At least one of the first and second positions may represent an outer extent of the location of interest. Thus for instance, using the example of a work crew on a rail network, the first and second acoustic sources may be located to indicate the outer limits, along the track, of the area that the crew is working in. This means that the control centre knows exactly where the work personnel will be along the length of the track. Thus any speed restriction on passing trains can be managed so that the trains are going the correct speed throughout the area of the work party but there is no unnecessary delay. Likewise the work party can be warned when the train reaches a certain distance of their actual location, rather than the general area, and thus down time of the work party may be reduced.

As the first and second acoustic sources may be relatively close together they may output different acoustic signals so as to aid discrimination. The first and second acoustic sources may operate at different frequencies and/or provide different coded sequences. The detected signals for the DAS sensor can then be analysed to detect the different frequencies or coding and thus identify the relevant source. This may be important if one source fails or can't be detected for some reason. If the first source is always used to indicate the start of the location of interest and the second source the end of the location of interest (for a predetermined direction of travel) then detection of a single source can still indicate the location of interest with a safety margin applied for the length of the location of interest.

As mentioned the area may comprise a transport network such as a rail or road network and the location of interest may be the location of a work party.

Additionally or alternatively however the location of interest may be the location of an emergency. The emergency could be the location of a breakdown, or a collision or any other emergency. Especially for road networks where there has been a collision it may be beneficial to know the extent of the road network affected by the collision. Deploying first and second acoustic sources marking the limits of the road affected by the collision, for instance by one of the emergency services or highways maintenance personnel, can provide the exact location of the collision to a control centre which will allow dispatch of additional support if needed and also allow more accurate traffic management controls to be implemented.

In some instances the acoustic source may only activated in the event of an emergency. Thus detecting the predetermined acoustic output is used to indicate the existence of an emergency. For areas which are routinely monitored using DAS the acoustic source could be used as an emergency beacon that provides remote indication of the existence and the location of an emergency via the DAS sensor or sensors. For instance on a rail network monitored by DAS each train may be provided with a DAS unit. In the event of a breakdown or other emergency the train operator may not only try to communicate via radio/telephone to indicate the current status but may also deploy an acoustic marker designed to be detectable by DAS. In the event of the failure of other communications the deployment of the acoustic source will indicate an emergency and even coupled with other communications the acoustic source will provide an indication of the location of the breakdown/emergency. This may allow the location of the breakdown to be automatically added to a network map and various controls to divert other trains implemented.

In general the invention relates to the use of an acoustic source as an beacon which is configured to be detectable by a DAS sensor and indicate a status apples to a variety of situations where optical fibre may be present to act as a sensing fibre. In other words the invention relates to the use of an acoustic source as a beacon in an area which is monitored by one or more DAS sensors. The beacon may identify a location of interest in the area monitored by the DAS sensor(s) and additionally may provide information such as the identity of the beacon and/or a status condition.

The acoustic source may be configured to be able to produce a plurality of different acoustic outputs, each indicative of a different status, and the method may comprise selecting an appropriate acoustic output. Thus for instance the source may produce a first signal to indicate that a work party is working on a track. As a train approaches the party may be warned of the arrival so they can clear the track. As the track is cleared they may change the output of the source to indicate an all clear signal. In the absence of such change the train may be prevented from entering the area. A variety of other statuses could be used in other situations.

The present invention thus provides a way of remotely indicating a location in an area monitored by DAS. Thus in another aspect of the invention there is provide a method of marking a location of interest for remote identification comprising: positioning an acoustic source configured to produce a predetermined acoustic output configured to be detectable by a distributed acoustic sensor at the location of interest and activating the acoustic source. This method offers all the same advantages and may be applied in the same ways as the first aspect of the invention.

Also the invention involves detecting a location of interest using DAS. Thus in a further aspect the invention provides a method of detecting a location of interest within an area comprising performing distributed acoustic sensing on at least optical fibre deployed at least partly within said area and monitoring the acoustic returns for a predetermined acoustic signal produced by an acoustic marker source positioned at the location of interest and, in the event of detecting said predetermined acoustic signal, determining the location of said acoustic marker source.

In general the invention relates to the use of an acoustic source to remotely indicate the location a location of interest within an area by detecting the location of the acoustic source by performing distributed acoustic sensing on at least one optical fibre deployed within the area.

The invention also applies to apparatus. Thus in another aspect there is provide a system for identifying a location of interest within an area comprising: an acoustic source positioned at the location of interest and configured to produce a predetermined acoustic output; at least one distributed acoustic sensor comprising at least one optical fibre deployed at least partly in said area; and a processor for analysing the acoustic signals detected by said distributed acoustic sensor to detect said predetermined acoustic sequence and determine the location of said acoustic source.

The system may be operated in all of the same ways as the method of the invention. The invention also provides for acoustic marker devices or beacons that can be used to remotely indicate location via DAS. In a further aspect therefore there is provided an acoustic marker configured for remotely indicating a location of interest comprising an acoustic source configured to produce a predetermined acoustic output configured to be detectable by a distributed acoustic sensor.

The acoustic source may be configured to be able to produce a plurality of different acoustic outputs, each indicative of a different status as described above.

The acoustic marker may be configured to automatically activate in response to detection of at least one emergency condition. For instance in the event of a train breakdown or collision an acoustic beacon on the train may automatically activate to relay information to a control room via DAS.

The invention will now be described by way of example only with respect to the following drawings of which:

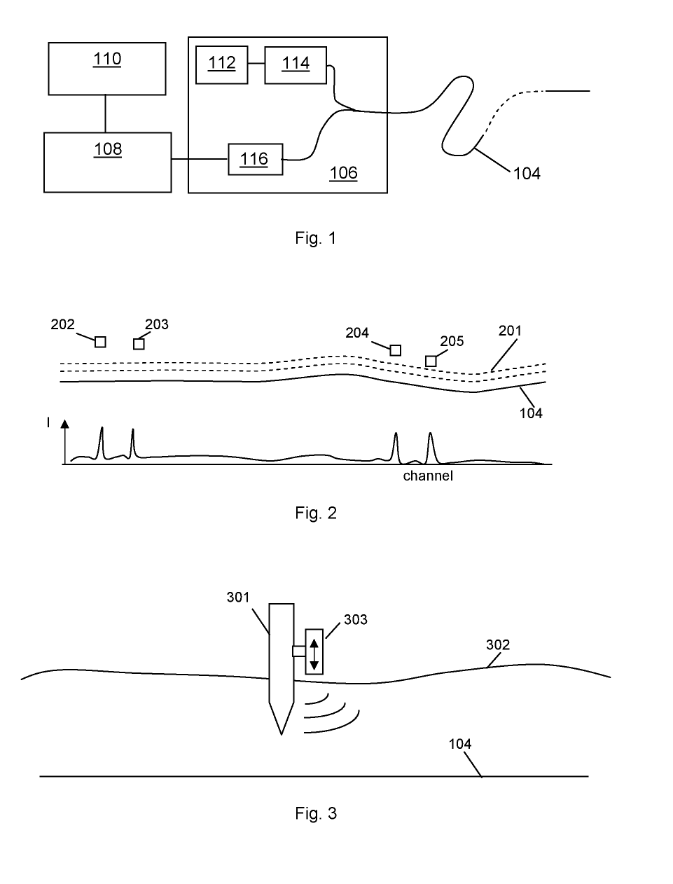

FIG. 1 shows a DAS sensor arrangement;

FIG. 2 illustrates the use of acoustic sources as markers in a transport network monitored by DAS;

FIG. 3 illustrates one suitable acoustic source; and

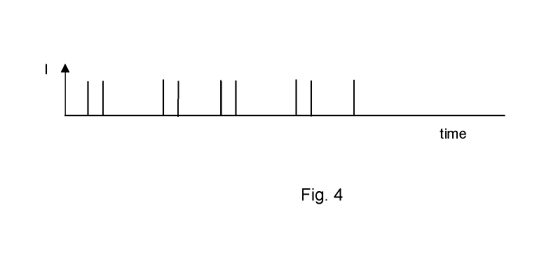

FIG. 4 illustrates an example acoustic coding.

FIG. 1 shows a schematic of a distributed fibre optic sensing arrangement. A length of sensing fibre 104 is removably connected at one end to an interrogator 106. The output from interrogator 106 is passed to a signal processor 108, which may be co-located with the interrogator or may be remote therefrom, and optionally a user interface/graphical display 110, which in practice may be realised by an appropriately specified PC. The user interface may be co-located with the signal processor or may be remote therefrom.

The sensing fibre 104 can be many kilometres in length and can be, for instance 40 km or more in length. The sensing fibre may be a standard, unmodified single mode optic fibre such as is routinely used in telecommunications applications without the need for deliberately introduced reflection sites such a fibre Bragg grating or the like. The ability to use an unmodified length of standard optical fibre to provide sensing means that low cost readily available fibre may be used. However in some embodiments the fibre may comprise a fibre which has been fabricated to be especially sensitive to incident vibrations. The fibre will be protected by containing it with a cable structure. In use the fibre 104 is deployed in an area of interest to be monitored which, in the present invention may be along the path of a transport network such as a road or railway as will be described.

In operation the interrogator 106 launches interrogating electromagnetic radiation, which may for example comprise a series of optical pulses having a selected frequency pattern, into the sensing fibre. The optical pulses may have a frequency pattern as described in GB patent publication GB2,442,745 the contents of which are hereby incorporated by reference thereto, although DAS sensors relying on a single interrogating pulse are also known and may be used. Note that as used herein the term “optical” is not restricted to the visible spectrum and optical radiation includes infrared radiation and ultraviolet radiation. As described in GB2,442,745 the phenomenon of Rayleigh backscattering results in some fraction of the light input into the fibre being reflected back to the interrogator, where it is detected to provide an output signal which is representative of acoustic disturbances in the vicinity of the fibre. The interrogator therefore conveniently comprises at least one laser 112 and at least one optical modulator 114 for producing a plurality of optical pulses separated by a known optical frequency difference. The interrogator also comprises at least one photodetector 116 arranged to detect radiation which is Rayleigh backscattered from the intrinsic scattering sites within the fibre 104. A Rayleigh backscatter DAS sensor is very useful in embodiments of the present invention but systems based on Brillouin or Raman scattering are also known and could be used in embodiments of the invention.

The signal from the photodetector is processed by signal processor 108. The signal processor conveniently demodulates the returned signal based on the frequency difference between the optical pulses, for example as described in GB2,442,745. The signal processor may also apply a phase unwrap algorithm as described in GB2,442,745. The phase of the backscattered light from various sections of the optical fibre can therefore be monitored. Any changes in the effective optical path length within a given section of fibre, such as would be due to incident pressure waves causing strain on the fibre, can therefore be detected.

The form of the optical input and the method of detection allow a single continuous fibre to be spatially resolved into discrete longitudinal sensing portions. That is, the acoustic signal sensed at one sensing portion can be provided substantially independently of the sensed signal at an adjacent portion. Such a sensor may be seen as a fully distributed or intrinsic sensor, as it uses the intrinsic scattering processed inherent in an optical fibre and thus distributes the sensing function throughout the whole of the optical fibre. The spatial resolution of the sensing portions of optical fibre may, for example, be approximately 10 m, which for a continuous length of fibre of the order of 40 km say provides 4000 independent acoustic channels or so deployed along the 40 km of fibre.

DAS has been employed in many environments and is being considered for deployed on transport networks, such as road or rail networks where long stretches of road or railway can be monitored. Often there is already optical fibre deployed along the length of the major routes of such network anyway.

FIG. 2 illustrates how the present invention could be used in one embodiment. FIG. 2 shows a section of a transport network, which in this example will be referred to as a railway 201 (which could be above ground or an underground railway) but it will be understood that the network section could be a section of road.

An optical fibre 104 which is monitored by a DAS sensor as described above is deployed along the length of the railway 201. Typically the optical fibre 104 may be buried alongside the railway but other arrangements are possible, for instance being buried under or attached to the track. The DAS sensor may be used during normal operation of the railway to provide a variety of control and/or monitoring functions. For instance the DAS sensor may be routinely used to track movement of trains on the network. The location of the optical fibre 104 along the railway 201 may thus be well known and the signals from the DAS sensor may be integrated into the railway control system, for instance the position of trains tracked by one or more DAS sensors may be displayed and/or plotted at a central control room.

In this example there are two work crews scheduled to work on different sections of the network but the section of network is to remain operational. Thus there is a desire to notify the works crews of the approach of a train so they can ensure the track is clear and all personnel are a safe distance from the track. Also there may be a need to impose a speed restriction on the train as it passes the areas being worked upon.

Conventionally the locations of the works crews would be planned in advance as far as possible and the work crews would thus proceed to the planned locations. A control room operator may then instruct trains to impose a speed restriction in the planned location and/or warn the crews as trains approached the planned locations. It is possible however the control centre could make a mistake with regard to the position of the planned location or the work crew could go to the wrong location. In either instance the work crew may not be where the control centre expects them to be and thus inadequate warnings or speed restrictions may be given.

Also it is possible that the planned location encompasses a wide area but the work crews only operate in a small part of that planned area at any one time. Thus it may be necessary to impose speed restrictions and give warning for the whole of the area—which may be inefficient.

In the embodiment of the present invention the works crews indicate their location to the control centre by positioning acoustic sources which can be detected by the DAS sensors via sensing fibre 104.

Thus the first work crew positions acoustic sources 202 and 203 in the area they are working, with the acoustic sources being positioned at the outer limits of the area they are currently working in. The acoustic sources are preferably easily man portable and thus can be easily repositioned as the work crew moves. In the scenario where the crew is working on or alongside a track which is provided with sensing fibre alongside the track the acoustic sources do not have to be particularly powerful as the fibre is located in the vicinity of the source. Thus relatively simple acoustic sources may be used.

FIG. 3 shows one example of an acoustic source 301 that may be used, especially with buried sensing fibres. The source may be a ground vibration source and may be mounted on the ground 302. In this example shown in FIG. 3 the source 301 is partly implanted into the ground 302 to provide good acoustic coupling. The source 301 has a hammer or thumper arrangement 303 arranged to be movable to create an impact to impart vibrations into the ground. In this instance the hammer strikes the ground directly but in other arrangements the hammer may strike a plate of the source. As illustrated the impact produced acoustic waves in the ground which will be detected by the buried fibre 104. Various other arrangements of acoustic sources may be used however and anything that creates a distinctive signal that can be detected by the DAS sensor could be used including many forms of acoustic transducer.

Referring back to FIG. 2 the first work crew thus positions the acoustic sources 202 and 203 and activates the sources. Further along the track the second work party can likewise position acoustic sources 204 and 205 at the limits of the area they are working in.

The DAS sensor will be able to detect the acoustic stimulus generated by the acoustic sources and determine the relevant location by looking at which of the sensing portions detect the acoustic signal. For this embodiment the location of interest is the location along the length of the track and thus the determination of location simply identifies how far along the track the sources are located. This can be done by looking for the sensing portions which detect the acoustic signals first—as the sensing portion closest to the source will receive the incident waves before the other sensing portions.

It will of course be appreciated that using appropriate fibre deployment and analysing the time of arrival it would be possible to locate the location of the source two dimensions if necessary.

FIG. 2 illustrates a generalised plot of intensity against channel (i.e. sensing portion) along the fibre length. The detected signals corresponding to the location of the sources can be clearly seen.

In order to aid detection and discrimination of the sources each of the acoustic sources produces a predetermined output. This allows the signals detected by the DAS sensor to be analysed for the predetermined output, thus aiding in discrimination compared to ambient noise or the activity of the work crew.

The output of each of the acoustic sources could be the same. In this instance the detection of two relatively close high intensity signals (corresponding to sources 202 and 203) can be taken to indicate the extent of the area of working of the first work party and likewise the detection of another two relatively close high intensity signals further along the track is taken as being indicative of the presence of the second work party.

It would be possible however to have at least some of the acoustic sources to provide different acoustic outputs. For instance the frequency of operation could be altered and/or the output could comprise a coded output. The output could comprise one or more pulses, i.e. periods of relatively intense acoustic stimulation, and the duration of the pulse(s) and/or time separation between pulses could provide the coding. The coding could also involve varying the frequency of the acoustic signals in a certain way. There are a variety of ways in which the acoustic output could be coded. The output from acoustic sources 202 and 203 provided to the first work party could therefore be different from those from sources 204, 205 provided to the second work party. This means that the individual work parties can be identified. This could be useful if the nature of the work that one work party is conducting means they require greater warning of train approach and/or a more severe speed restriction to be applied. Also the sources provided to the work crews may provide different output to one another and may be arranged to be used to mark the start and end of the location of interest in a given direction.

When both work parties have positioned and activated the relevant acoustic sources the signals will be detected by the DAS sensor and relayed to a control centre. The control centre can thus get accurate, real-time information about the actual location of the work crews and the extent of the area they are working in. This will be automatically updated if the works crews move and reposition the acoustic sources. This can allow identification of if the work crew is in the wrong place and also allow more precise warning and restrictions to be employed.

The DAS sensor can also be used to track train movement on the railway—even if it is not normal used for monitoring. The passage of a train on the railway can thus be tracked. When the train reaches a certain distance from the position of a work party—which may depend on the train speed and, as mentioned above, the amount of notice required by the relevant work party, the control room may notify the work party of the impending arrival of the train. In one embodiment the acoustic source 301 may have the facility for remote communications and it may be provided with one or more alarm devices, such as warning lights and/or loudspeakers which can be remotely activated by the control room to warn the work party of the impending arrival of the train. Thus the acoustic source could have a ground impulse for generating a coded acoustic signal that can be detected by the DAS sensor. It may also have one or more loudspeakers that may be remotely activated by a controller (which may or may not be automated) to warn the work party to clear the area. The acoustic signal generated by the loudspeaker may also be detectable by the DAS system—which means that the DAS sensor will be able to detect whether the loudspeaker has activated correctly and the work party has received warning. Of course other means for alerting the work party could be used, such as a controller calling the work party on a radio or mobile telephone.

However warned the work party may then clear the track and may indicate to the control room that it is safe for the train to pass. In some embodiments this may be changing the output of the acoustic sources to indicate an all clear signal. If the control room does not detect the all clear signal it may prevent the train from advancing into the relevant area.

Also the control centre may be communicating with the incoming train to impose speed restrictions on the train a certain distance from the location of the work party, or ensuring that the train can slow to a desired speed in time. As the movement of the train is tracked by the same system that determines the location of the work party (and which may indicate whether it is safe for the train to pass) the movement of the train may be accurately controlled to ensure safety but reduce any delays or speed restrictions to a minimum.

Using the same system that tracks train movement to identify the location of the work party provides an inherent protection against false identification of location—provided that the acoustic beacons are located correctly. As the beacons are simply placed at the position that the work party is at the possibility of false reporting is low.

The example discussed in relation to FIG. 2 has concerned work crews on a railway but the same principles apply to other transport networks, such as roads, and/or the location of other events of interest. For instance network section 201 could be a road and source 202 and 203 could indicate a breakdown event causing tailbacks in one direction (with the positioning of the two sources producing different outputs indicating the direction) and sources 204 and 205 could indicate the extent of a collision in the same or opposite direction.

As mentioned above the acoustic sources may be conjured to produce coded sequences. The acoustic source may be provide with a number of selectable coded sequences, each that indicates a different status. As mentioned above when used on a road network say one output could indicate a breakdown whilst another indicates a collision. The coded sequences could comprise repeating acoustic patterns with different time separations, for example as illustrated in FIG. 4. Detecting the acoustic signal having a particular pattern would therefore indicate the particular status. In some instances an acoustic source may be activated only in the event of an emergency and thus provides a way of indicating the existence of an emergency as well as its location.

In the examples discussed above the location of interest is the location along the length of a railway along which the sensing fibre(s) for the DAS sensor(s) are provided. Thus it is sufficient to determine the location of the source along the length of the relevant sensing fibre. The acoustic sources will, in use, therefore be positioned relatively close to the sensing optical fibre(s) in use—which as mentioned means that relatively low power sources may be used. In such embodiments the area being monitored is effectively an elongate but relatively narrow area running along the path of the fibre.

In some applications however the area being monitored within which it may be wished to identify a location may be much wider and one or more optical fibres may be arranged to monitor the whole of said area. In such applications it may be wished to identify or mark a location of interest which may be offset from a sensing fibre. In such applications the acoustic sources may be capable of generating an acoustic stimulus which may be detectable by a DAS sensor from a relatively long distance. A ground stimulus acoustic source such as The DAS sensor(s) may therefore be arranged to detect the predetermined acoustic signal and to locate the origin of the predetermined acoustic signal within a two-dimensional area. The location of the origin of an acoustic signal may be determined from time of arrival analysis from a suitably deployed fibre or fibres as well be well understood by one skilled in the art.

In some applications the acoustic signals used to identify the location of interest may be deliberately generated by an individual rather than an acoustic transducer. For example in application to rail network monitoring an individual could create an acoustic signal having the predetermined sequence by striking the ground or another object in the required sequence. For example if a rail worker identifies a problem with a section of rail they could signal the existence of a problem and the location of the problem to the control centre by generating an acoustic signal in the predetermined sequence. They could for instance strike the rail with a hammer in a desired pattern to generate a sound that is clearly detectable by the DAS sensor. This avoids the need for a dedicated acoustic source and means anyone who knows the sequence can communicate directly to the control centre via a DAS monitoring system. A train driver who experiences a fault which includes a communications failure could generate a predetermined acoustic signal indicating distress by striking the rail. Alternatively in some instances the fibre optic cable used for DAS sensing may be at least partly exposed in some areas and thus a detectable acoustic signal could be generated by tapping on the casing of the fibre optic cable.

In some instances where optical fibre is located along the path of a linear structure, such as a railway or pipeline, there may be one or more areas of cable loops where the length of fibre optic cable is greater than the length of the path of the linear structure. In other words in some sections of the path of a linear structure, if the length of the structure is is x metres long then there is x metres of fibre optic cable (or just slightly more) so that the cable runs alongside the structure. In another section however a length of x metres of the path of the structure may be provided with x+y meters of cables where y may be several metres or tens of metres of cable. In this areas therefore part of the cable may be looped in one or more fibre loops.

Such fibre loops may accidentally result when laying the cable or they may be deliberately introduced to provide ‘spare’ cable in the event of the need to reposition the cable at a later date or to remove a damaged section of cable.

The presence of such loops will of course create a mismatch in certain areas between the length of the sensing fibre and the length of the linear asset being monitored. The presence of such loops may therefore be detected in an initial calibration/set-up phase for a DAS monitoring system and the signal returns from such loops may therefore be discounted when monitoring the linear asset in use.

In embodiments of the present application such fibres loops could be used as a part of the DAS monitoring network which can be used to indicate a status along the lines discussed above. For instance if such loops are spaced at relatively regular intervals along a railway then, in the event of an emergency, an individual such as a train driver may b able to located the nearest such loop and create an acoustic signal for instance by tapping on the casing of the fibre optic cable (if exposed) or hitting the ground or rail with an items such as a hammer. Detection of a signal from such a part of the sensing fibre could be used as detection of an emergency situation and the location of the loop along the fibre will indicate the general location of the emergency.

1. A method of identifying a location of interest within an area comprising:
positioning an acoustic source at the location of interest;
activating the acoustic source to produce a predetermined acoustic output;
performing distributed acoustic sensing on at least one optical fibre deployed at least partly in said area; and
analysing the acoustic signals detected by said distributed acoustic sensing to detect said predetermined acoustic sequence and determine the location of said acoustic source.

2. A method as claimed in claim 1 wherein said predetermined acoustic output comprises at least a first coded sequence.

3. A method as claimed in claim 1 wherein said acoustic source comprises a ground vibration source.

4. A method as claimed in claim 1 comprising locating at least a first acoustic source at a first position at the location of interest and a second acoustic source at a second position at the location of interest.

5. A method as claimed in claim 4 wherein at least one of the first and second positions represents an outer extent of the location of interest.

6. A method as claimed in claim 4 wherein the first and second acoustic sources output different acoustic signals.

7. A method as claimed in claim 6 wherein the first and second acoustic sources operate at different frequencies and/or provide different coded sequences.

8. A method as claimed in claim 1 wherein the area comprises a transport network.

9. A method as claim in claim 8 wherein the transport network comprises a rail or road network.

10. A method as claimed in claim 8 wherein the location of interest is the location of a work party.

11. A method as claimed in claim 8 wherein the location of interest is the location of an emergency.

12. A method as claimed in claim 1 wherein the acoustic source is only activated in the event of an emergency and detecting the predetermined acoustic output is used to indicate the existence of an emergency.

13. A method as claimed in claim 1 wherein the first acoustic source is configured to be able to produce a plurality of different acoustic outputs, each indicative of a different status, and wherein the method comprises selecting an appropriate acoustic output.

14. A method of marking a location of interest for remote identification comprising: positioning an acoustic source configured to produce a predetermined acoustic output configured to be detectable by a distributed acoustic sensor at the location of interest and activating the acoustic source.

15. A method of detecting a location of interest within in an area comprising performing distributed acoustic sensing on at least optical fibre deployed at least partly within said area and monitoring the acoustic returns for a predetermined acoustic signal produced by an acoustic marker source positioned at the location of interest and, in the event of detecting said predetermined acoustic signal, determining the location of said acoustic marker source.

16. (canceled)

17. A system for identifying a location of interest within an area comprising:
an acoustic source positioned at the location of interest and configured to produce a predetermined acoustic output;
at least one distributed acoustic sensor comprising at least one optical fibre deployed at least partly in said area; and
a processor for analysing the acoustic signals detected by said distributed acoustic sensor to detect said predetermined acoustic sequence and determine the location of said acoustic source.

18. An acoustic marker configured for remotely indicating a location of interest comprising an acoustic source configured to produce a predetermined acoustic output configured to be detectable by a distributed acoustic sensor.

19. An acoustic marker as claimed in claim 18 wherein the acoustic source is configured to be able to produce a plurality of different acoustic outputs, each indicative of a different status.

20. An acoustic marker as claimed in claim 19 configured to automatically activate in response to detection of at least one emergency condition.
